(19) United States
(12) Patent Application Publication
(10) Pub. No.: US 2013/0130896 A1
(43) Pub. Date: May 23, 2013

(54) FOLIAR FERTILIZERS FOR CONTROLLING PESTS

(71) Applicant: Luiz Dimenstein, Nes Ziona (IL)

(72) Inventor: Luiz Dimenstein, Nes Ziona (IL)

(73) Assignee: ROTEM AMFERT NEGEV LTD., M.P. Arava (IL)

(21) Appl. No.: 13/813,202

(22) PCT Filed: Aug. 4, 2011
(86) PCT No.: PCT/IL2011/000633

§ 371 Date: Jan. 30, 2013

(30) Foreign Application Priority Data
Aug. 12, 2010 (IL) 207591

(51) Int. Cl. C05B 17/00

(52) U.S. Cl. CPC C05B 17/00
USPC 504/101

(57) ABSTRACT

Provided is an environmentally friendly and broadly applicable method for protecting plants or crop against pests and diseases by successive foliar sprays with aqueous liquids exhibiting high acidity or basicity. The sprays provide protection, and further supply the plant with phosphorus and potassium.

### FIELD OF THE INVENTION

The present invention relates to a broadly applicable method of protecting plants or crop against pests and diseases, by successive foliar sprays of plant nutrients in aqueous solutions of extreme pH values, without employing toxic organic materials.

### BACKGROUND OF THE INVENTION

The intensive use of pesticides in agriculture lowers the quality of environment and endangers human health. Many toxic chemicals have been used as pesticides, some have been banned, while others are still in use. Pesticides have broad and often unexpected effects on the environment. The most of sprayed pesticides reach other than the intended targets; damaging pollinators, for example, causes losses on crop, whereas reducing the bird populations may indirectly help the pests. Some pesticides remain in soil, an may end up in drinking water and food. Some pesticides resist degradation, remain in the environment for years, and may travel great distances through the atmosphere to become deposited in remote regions. Pesticides may bioaccumulate, and increase their concentrations many times in certain organisms and organs. In humans, reported was the increased risk of cancer; neurobehavioral disorders, infertility, immune disorders, and others. Chronic effects can be hardly assessed. Another serious problem is resistance to pesticides which often evolves in the pests. There has been a long felt need for less invasive pest control. Kolodziej et al. showed a protective effect of foliar fertilization applied on a medicinal herb, American ginseng, when a phosphate exhibiting very high pH was used [Kolodziej B. et al.: Proc. 1^{st} IC on Culinary Herbs, Eds.: K. Turgut et al., Acta Hort. 826, ISHS 2009]. Fertilizers are usually added to the soil, but it is known that the plants can absorb nutrition which is applied directly onto the leaves. EP 1386897 describes a phosphorus containing foliar fertilizer, the composition being buffered to maintain the pH values between 6.5 and 8.5. It is an object of this invention to provide a method for protecting plants against pests, comprising a foliar fertilizer.

It is another object of this invention to provide a universally applicable method for protecting a broad variety of plants important for agriculture and industry against various types of pests.

It is still another object of this invention to provide an efficient method of protecting plants against pests, which method would be environmentally-friendly.

It is a further object of this invention to provide, by successive foliar sprays, nutrients to plants while reducing the pest infestation.

Other objects and advantages of present invention will appear as description proceeds.

### SUMMARY OF THE INVENTION

The present invention provides a method of controlling plant pests and diseases comprising a plurality of sequential applications of foliar liquid fertilizers having extreme pH values. Where extreme pH is mentioned, intended is a pH value lower than 4.0 or higher than 9.0. Said sequential applications may comprise alternating applications of acidic/alkaline fertilizers, or alkaline/acidic fertilizers, or repeating applications of acidic/acidic fertilizers or alkaline/alkaline fertilizers. Any combination of alternating and repeating applications may be employed, without limitation, during the crop cycle of life. Of course, the plant or crop should not be damaged by the spray. In a preferred embodiment of the method for protecting plants against pests and diseases, said fertilizers are derived from potassium and phosphate fully soluble sources. Said sequential applications preferably follow each other in the intervals of about 2 up to 20 days. The intervals of application vary according to the field intensity of the pests infestation or diseases. In some applications, a sequence of sprayings is repeated for increasing the treatment efficiency; the same sequence of certain sprayings may be repeated once or more times, forming a series of the same sequences. In a preferred embodiment, the sprayings employ concentrations of the fertilizers of from 0.2 wt % to 2.0 wt %.

The invention provides a kit for protecting plants against pests and diseases, comprising instructions and two foliar solid-soluble or already liquid fertilizers for sequential application onto said plants having extreme pH values differing at least by 5 pH units. Said kit consists of foliar fertilizers which provide extreme pH when dissolved in water, the fertilizers are pre-weighed in bags. Preferably, in one set of bags there are well-denoted bags, each corresponding to one spraying; the volumes of water to which the bags are dissolved are well described, as well as the time intervals between the sprayings. Alternatively, the fertilizers for the kit are in the liquid form in bottles or other adequate container for liquid fertilizers.

### DETAILED DESCRIPTION OF THE INVENTION

It has now been found that spraying crop with a sequence of sprays greatly differing in their pH is surprisingly effective in clearing the crop from pests and diseases infestation. The invention employs aqueous compositions for foliar spraying, comprising soluble or liquid fertilizers having extreme pH values, to be sequentially applied onto the plant, so creating unfriendly environment for pests and diseases. “Extreme pH” means usually a pH less than pH 4 or greater than pH 9. These types of fertilizers can be used for nearly every crop. The frequency of the application should be preferably performed in intervals of from 2 days to up to 20 days during the crop growth period. The composition comprises components that are soluble plants nutrients, and further foliar additives improving the efficiency of the foliar application, and facilitating the handling of the products. In the most preferred aspect of the instant technology, two compositions exhibiting two different extreme pH values are applied, preferably one having extremely basic pH and the other having extremely acidic pH. The basic and acidic compositions are applied sequentially, in at least two spray actions. Usually, three spray actions are sequentially employed, but sequences of more spraying actions may be used. In a preferred embodiment of the invention, two compositions are applied alternately, ach new spray changing the pH of the environment, the change occurring preferably more times. In another embodiment, one composition may be used repeatedly. The first spray changes the ambient pH from normal, approximately neutral value, the second spray changes the pH value again, and so on. In one embodiment, two different compositions achieve two pH changes in two spraying actions. In other embodiment, two different compositions achieve three pH changes in three spraying actions. In still another embodiment, three different compositions achieve three pH changes in three spraying actions. The term “pesticide” as used herein relates to agrochemicals protecting against any pests and diseases that attack plants; usually the term includes insects, fungi, or bacteria, but other pests may be included. The term pathogen is sometimes used interchangeably with the term pest. The pesticides used in agriculture are used mostly at a slightly acidic pH, usually in a narrow range of 4.5-6.5, to get the best action against the pests and diseases. Many pesticides undergo alkaline hydrolysis at pH higher than about 7 and lose their efficiency. The instant invention relates to pesticidal effects at pH far from neutral. Furthermore, the compositions according to the invention add fertilizing value, beside the pesticidal effects. In a preferred embodiment, the invention achieves extreme pH changes by means of potassium and phosphates. Many available fertilizers include nutrients, for example various micronutrient, which can cause overdose and may be toxic if applied repeatedly during the crop grow cycle. On the other hand, the use of macronutrients like P/K (phosphorus/potassium) usually does not lead to overdose, and when applied as foliar fertilizer, they complement the P/K coming from soil. The pH effect occurs in solution, but not in dry phase. The materials may be used, for example, in a concentration of about 1%. The effect is maintained while the leaves stay wet and humid; therefore, it is preferable to slow the evaporation process as much as possible, for example by spraying the plant at the end of the day to keep the pH effect by for long hours during the night and even at beginning of the next morning.

Sometimes, after drying the solution, the acidic or basic material may work again when the dew of the next day provides water. Often, a few hours of wet environment comprising an extreme pH on the plant surface is enough to at least inhibit the normal development of plant pests, for example, by interfering with some stages of insects development, such as the development from egg to larva and to the next stages. The high difference between the inner pH of the pathogen and the outer pH in the environment inhibits the body processes and may even disrupt the cell membrane by influx or efflux of protons. Most pathogens do not tolerate a difference higher than about two pH units across cell or organelles membranes lasting more than a few hours. It is believed that when several pH changes occur sequentially, the interference is synergistically stronger. When, for example, in one embodiment of the invention, the pH on the plant leaves is changed from the normal pH close to neutral to very acidic and/or to very alkaline within a few days, the shock may irreversibly damage the pest development, or at least inhibit its normal development and the reproduction capacity—at least to such a degree that the pest cannot anymore afflict practical damages. The extreme pH sprays are applied repeatedly until the infestation intensity of the pests and diseases decreases. Still more preferably, additional sprays and pH changes represent a shock, precluding any tentative adaptation of pest agents. Such a spray sequence is an efficient new strategy in combating a variety of pests, even adaptable pests. Often, it is not necessary to change the pH to an extreme value at every stage, enough is to make the pH jump in the environment. In one aspect, the invention aims at controlling plant pests by sequential applications of foliar liquid fertilizers having extreme pH values, either by repeating applications of acidic products or alkaline products, or by alternating acidic and alkaline products differing by at least 5 pH units. Repeatedly applied sprays causing the pH changes provides an effective, cheap, and environmentally friendly way of fighting plant pests.

The invention provides a kit comprising several bags with solids to be dissolved in water, or several solution for spraying, including acidic and alkaline fertilizers. The selection of the type of acid or base, their concentrations, and the intervals between the sprays depend on the type of pest to combat, the plant or crop to be protected, the plant age, the degree of infestation, weather, etc. In some cases, the information about the pest sensitivity can be obtained and can be utilized in optimizing the working parameters. The invention enables to efficiently treat a plant even without prior knowledge about pest sensitivity. A universally efficient first spray is initially applied, and its effects on the pests are evaluated, enabling to better choose a second spray. The foliar fertilizers are applied in aqueous solutions at a concentration of from about 0.2 wt % to about 2.0 wt %. The lower concentration is recommended to young plants and some vegetables that are very sensitive, while the solution concentration can increase for adult plants and for strong plants. A skilled person will easily calculate fertilizers weights and water volumes to be used for the foliar applications. The optimization may include minimizing the amounts of used agrochemicals, in some cases. In other cases, higher amounts of the used agrochemicals are not avoided. In some cases, the weather may influence practical decisions in regard to the amounts and intervals. The rain, for example, washes off the residues of the last spray.

The preferred material exhibit suitable pH, solubility, easy handling, and is rich in P/K. According to the kind of crop and the phytosanitary status, additional sprays can be necessary to get effective pest and disease control, more in case of perennial plants than for the annual crops or vegetables of short life cycle.

The pH on the leaves after spraying gradually returns from the extreme value toward neutrality in few hours. In some cases, the same product (providing the same extreme pH as before) may be applied, and the repeated shock will be efficient against the pest, even though the extreme pH will have the same value in two successive sprayings. In many cases, the successive spray has different pH, which is usually more efficient and also precludes eventual adaptation by the pathogen to a specific pH. Repeated spraying, including a sequence of sprays or series of sequences, destroys more reliably even the residues of the pathogens, and further prevents or complicates to the pathogens their eventual migration from adjacent fields. The treatment according to the invention is universally very effective. An example of plants to be protected includes, for example, apples, tomatoes, soybeans, cotton, and others.

The invention will be further described and illustrated in the following examples.

### EXAMPLE

### Materials

Two blends based on phosphate and potassium, prepared from fully soluble and clean raw materials, were dissolved in water to the concentration of 1 wt %; the pH of the solution was less than 4 for the acid blend and higher than 9 for the alkaline one.

### Method

Two melon plots, strongly infested by leaf miner (Liriomyza ssp.), were treated against leaf miner pest (Mossoro in Brazil, November 2009). The leaf miner fly had been the main pest problem in the area. The first field was sprayed every third day by a classical pesticide, more types of pesticides were applied. The second plot was treated in accordance with the method of the invention. The treatment according to the invention included a sequence of nine spraying prepared as described above. Each spraying employed between 600-1000 liters/hectare, the intervals between the sprayings in the sequence were 4-5 days, for the 3 first sprays; then after 12 days followed 3 sprays in 4-5 days intervals; finally, after 10 days, the last 3 sprays followed again in 4-5 days intervals. During all the growth period, the melon leaves were cleaner from leaf miner in the plot treated according to the invention when compared with the plot treated with the regular pesticides.

It was surprising to find that classical insecticide did not stop the infestation; despite the treatment, galleries were formed in the leaves, and finally even larvae of Liriomyza appeared. As for the treatment according to the invention, it was observed that the pH changes inhibited the insect development at the larval stage. The 1% concentration of the spray solution and the high volume increasing according to the crop age from 600 up to 1000 liters/hectare was very good for covering the foliage. The treatment according to the invention stopped the pests intensity, and usual galleries carved in the leaves by the pest were not observed at all or only slight presence was perceptible, without economic damage for the crop.

While this invention has been described in terms of some specific examples, many modifications and variations are possible. It is therefore understood that within the scope of the appended claims, the invention may be realized otherwise than as specifically described.

1. A method of controlling plant pests comprising a plurality of sequential applications of foliar liquid fertilizers having extreme pH values comprising at least two fertilizers differing by at least 5 pH units.

2. A method according to claim 1, wherein said pH values are lower than 4.0 or higher than 9.0.

3. A method according to claim 1, wherein each application differs by at least 5 pH units from the previous one.

4. A method according to claim 1, wherein one of said fertilizers comprises fully soluble sources of phosphate and potassium, as the base of the blends for both acidic and alkaline products.

5. A method according to claim 1, wherein said sequential applications follow each other in the intervals of about 2-20 days.

6. A method according to claim 1, wherein a sequence of sprayings is repeated once or more times in a series.

7. A method of controlling plant pests according to claim 1, comprising a sequence of sprayings, including solutions of blend of P/K having a concentration of from 0.2 wt % to 2 wt %.

8. A kit for protecting a plant against pests, comprising instructions and two foliar liquid fertilizers for sequential application onto said plant, the fertilizers having extreme pH values differing from each other by at least 5 pH units.

9. A kit according to claim 8, consisting of blends of P/K in at least two bags, wherein the content of each bag is intended for dissolving in a predetermined amount of water and for spraying sequentially onto said plant according to said instructions.

10. A kit according to claim 8, providing an effective, cheap, and environmentally friendly protection to plants against pests selected from insects, fungi, or bacteria, while precluding adaptation of the pests to said extreme pH, wherein said fertilizers are soluble in water and lack toxic organic materials.
